(19) United States
(12) Patent Application Publication
(10) Pub. No.: US 2006/0110660 A1
(43) Pub. Date: May 25, 2006

(54) Lithium secondary battery and method of manufacturing the same

(76) Inventors: Kazuyuki Satou, Itano-gun (JP); Toshikazu Yoshida, Itano-gun (JP); Ikuro Nakane, Kobe-shi (JP); Toshio Yanagida, Itano-gun (JP)

Correspondence Address: KUBOVCIK & KUBOVCIK, SUITE 710, 900 17TH STREET NW, WASHINGTON, DC, 20006, US

(21) Appl. No.: 11/263,836

(22) Filed: Nov. 2, 2005

(30) Foreign Application Priority Data
Nov. 2, 2004 (JP) 2004-318732
Mar. 3, 2005 (JP) 2005-099037

(51) Int. Cl. H01M 4/58; H01M 4/04

(52) U.S. Cl. 429/231.95; 429/128; 29/623.1

(57) ABSTRACT

A lithium secondary battery employing as its negative electrode active material a material that increases in volume by alloying with lithium during charge achieves high discharge capacity and good cycle performance. The lithium secondary battery includes a negative electrode having a negative electrode active material (2) and a negative electrode current collector, a positive electrode having a positive electrode active material (1) and a positive electrode current collector (3), and a non-aqueous electrolyte. The negative electrode active material (2) is a material that increases in volume by alloying with lithium during charge. The negative electrode active material (1) is arranged so as to be on, and in contact with, the negative electrode current collector. The negative electrode active material (2) contains, when in an end-of-discharge condition, 8% or more of lithium with respect to the total capacity of the negative electrode active material (2) as measured when it does not contain lithium.

### BACKGROUND OF THE INVENTION

1. Field of the Invention

The present invention relates to lithium secondary batteries and a method of manufacturing the batteries. More particularly, the invention relates to lithium secondary batteries using a material alloyed with lithium as their negative electrode active material, and methods of manufacturing the batteries.

2. Description of Related Art

When a lithium secondary battery uses a carbon-based material for its negative electrode active material, the negative electrode active material does not expand significantly during charge. On the contrary, when using a material alloyed with lithium, such as silicon, the active material expands very greatly, about four times in volume, during charge. Thus, when using a material alloyed with lithium as the negative electrode active material, the active material expands and shrinks by charge-discharge cycling, producing stress that causes the active material to peel off. This causes degradation in current collection performance, leading to the problem of poor cycle performance.

Published PCT Application WO 01/29913 discloses that the expansion and shrinkage of active material can be alleviated by forming the active material made of silicon or the like into a thin film divided by gaps that form along its thickness to form columnar structures, and that battery cycle performance can be thereby improved considerably.

Japanese Published Unexamined Patent Application No. 7-29602 discloses that the use of a negative electrode active material in which lithium ions are contained in silicon by an electrochemical reaction can prevent production of irreversible substances due to overcharge and overdischarge, thus improving battery cycle performance.

Japanese Published Unexamined Patent Application No. 5-144472 discloses a method of manufacturing a lithium secondary battery employing a carbon-based material as its negative electrode active material, in which metallic lithium is affixed to the negative electrode for the purpose of preventing battery deterioration due to overdischarge.

With the lithium secondary battery as disclosed in Published PCT Application WO 01/29913, which uses the negative electrode having columnar structures formed of a silicon thin film or the like, however, pre-doping of the negative electrode active material with lithium has not been studied, and the advantages thereof have not been confirmed.

### BRIEF SUMMARY OF THE INVENTION

Accordingly, it is an object of the present invention to provide a lithium secondary battery having high discharge capacity and good cycle performance, the battery employing, as its negative electrode active material, a material that increases in volume during charge by alloying with lithium, and to provide a method of manufacturing the battery.

The present invention provides a lithium secondary battery comprising: a negative electrode having a negative electrode active material and a negative electrode current collector; a positive electrode; and a non-aqueous electrolyte, wherein the negative electrode active material is composed of a material that increases in volume by alloying with lithium during charge, and the negative electrode active material is directly in contact with the negative electrode current collector, and the negative electrode active material contains, when in an end-of-discharge condition, 8% or more of lithium (in terms of capacity (mAh/cm²)) with respect to a total capacity of the negative electrode active material as measured when the negative electrode active material does not contain lithium.

### BRIEF DESCRIPTION OF THE DRAWINGS

FIG. 1 is a cross-sectional view illustrating a wound electrode assembly according to one example of the present invention;

FIG. 2 are plan views illustrating the obverse side (a) and the reverse side (b) of the positive electrode as well as the obverse side (c) and the reverse side (d) of the negative electrode according to an example of the present invention;

FIG. 3 is a cross-sectional view illustrating a wound electrode assembly according to another example of the present invention;

FIG. 4 is a view showing the condition of the negative electrode of Example 13 in a charged state after an aging process; and

FIG. 5 is a view showing the condition of the negative electrode of Example 14 in a charged state after an aging process.

### DETAILED DESCRIPTION OF THE INVENTION

According to the present invention, battery cycle performance is enhanced because the negative electrode active material contains, in the end-of-discharge condition of each charge-discharge cycle, 8% or more of lithium with respect to the total capacity of the negative electrode active material as measured when the negative electrode active material does not contain lithium. During a discharge process, the negative electrode active material shrinks in volume because lithium is deintercalated from the negative electrode active material. The lithium deintercalation reaction occurs most easily in a portion near the current collector, where electric field is most intense. The deintercalation of lithium causes the active material to shrink in volume, and consequently, very small cracks develop in the surface of the active material. When many such cracks develop near the current collector, the strength of the active material near the current collector degrades, causing the active material to peel off from the current collector. This degrades current collection performance and lowers cycle performance. In the present invention, the negative electrode active material contains, when in the end-of-discharge condition, 8% or more of lithium with respect to the total capacity of the negative electrode active material. Therefore, it is possible to prevent such very small cracks as mentioned above from occurring in the active material surface even in the end-of-discharge condition. Consequently, the active material can be prevented from peeling off from the current collector, making it possible to maintain good current collection performance and to obtain good cycle performance. It should be noted that in the present invention, the “lithium contained in the negative electrode active material” is intended to include the lithium contained in a lithium-compound surface film adhering on the negative electrode active material surface.

In the present invention, the end-of-discharge condition refers to a condition of a fabricated lithium secondary battery at the time when the battery voltage reaches a predetermined end-of-discharge voltage. When using transition metal oxides such as lithium-containing cobalt oxide, lithium-containing nickel oxide, and manganese oxide as the positive electrode active material, the end-of-discharge voltage is generally set at about 2.75 V. When the battery voltage reaches this end-of-discharge voltage, the battery is regarded as being in the end-of-discharge condition.

The total capacity of the negative electrode active material as measured when the negative electrode active material does not contain lithium can be found as the charge capacity at the first cycle of a three-electrode cell prepared using the negative electrode as its working electrode and charged to a potential of 0 V. In the three-electrode cell, metallic lithium is used as the counter electrode and the reference electrode.

The amount of lithium that the negative electrode active material contains in the end-of-discharge condition is preferably 8% or more of the total capacity as mentioned above, and more preferably 20% or more. Although the upper limit of the amount of lithium that is to be contained in the negative electrode active material is not particularly limited, it is generally preferable that the upper limit be 80% or less.

The negative electrode active material in the present invention may be a material that increases in volume by alloying with lithium during charge, and examples include silicon, tin, and aluminum. The negative electrode active material in the present invention is provided so as to be directly in contact with the negative electrode current collector. Thus, it is not adhered onto the negative electrode current collector via a binder or the like. Examples include those formed by depositing a thin film of negative electrode active material from a vapor phase or a liquid phase. Examples of the method for depositing a thin film from a vapor phase include CVD, sputtering, evaporation, and thermal spraying. Examples of the method for depositing a thin film from a liquid phase include plating such as electroplating and electroless plating.

It is preferable that the negative electrode in the present invention be such that a thin film as disclosed in Published PCT Application WO 01/29913 is divided by gaps that form along its thickness to form columnar structures, and bottom portions of the columnar structures are in close contact with the negative electrode current collector. In such an electrode structure, spaces form around the columnar structures, and these spaces absorb the expansion and shrinkage of the active material, preventing stress from occurring. It is preferable that such gaps that form along the thickness of the active material thin film be formed by expansion and shrinkage of the active material thin film due to charge-discharge cycling. In particular, when irregularities exist in the current collector surface, the gaps can easily form. That is, when forming an active material thin film by depositing it on a current collector having irregularities, it is possible to form irregularities corresponding to the irregularities in the current collector surface, which is the base layer, also on the exposed surface of the active material thin film. In the regions that join the valleys of the irregularities in the thin film and the valleys of the irregularities in the surface of the current collector, low-density regions tend to form. Consequently, gaps are formed along such low-density regions, whereby the thin film is divided into columnar structures.

It is preferable that the negative electrode active material in the present invention be an amorphous thin film or a microcrystalline thin film. It is preferable that the thin film be a silicon thin film or a silicon alloy thin film. Examples of the silicon alloy include those containing silicon at 50 atomic % or more, such as Si—Co alloy, Si—Fe alloy, Si—Zn alloy, and Si—Zr alloy.

In the present invention, it is preferable that the negative electrode active material be pre-doped with lithium prior to charge and discharge so that the content of lithium in the active material in the end-of-discharge condition will be 8% or more.

The present invention also provides a method of manufacturing the foregoing lithium secondary battery, comprising the steps of: prior to assembling the battery, preparing the negative electrode, the positive electrode, the non-aqueous electrolyte, and a battery case for accommodating the electrodes and the electrolyte; pre-doping the negative electrode active material with lithium prior to charge and discharge so that 8% or more of lithium is contained in the negative electrode active material in the end-of-discharge condition; and completing the lithium secondary battery with the negative electrode pre-doped with lithium, the positive electrode, the non-aqueous electrolyte, and the battery case.

Examples of the method for pre-doping the negative electrode active material with lithium prior to charge and discharge include a method of pre-doping with lithium using an electrochemical technique. An example is a technique in which the negative electrode and metallic lithium are immersed in the non-aqueous electrolyte so as to pre-dope the negative electrode active material with lithium originating from the metallic lithium. Another example is a technique in which a battery is prepared using metallic lithium as the counter electrode, and the negative electrode is charged prior to assembling the battery so that the negative electrode active material of the negative electrode is pre-doped with lithium.

For the step of pre-doping in the present invention, it is preferable to use a technique of immersing the negative electrode and the metallic lithium into the non-aqueous electrolyte. Specifically, the technique involves introducing the non-aqueous electrolyte into the battery case while the negative electrode and the positive electrode are arranged in the battery case and a partial region of the negative electrode is in contact with the metallic lithium, whereby the negative electrode active material is pre-doped with lithium from the metallic lithium. It is preferable that the region of the negative electrode that is brought in contact with the metallic lithium be a region of the negative electrode active material or a region of the negative electrode current collector that does not oppose the positive electrode active material of the positive electrode. Accordingly, it is preferable that the metallic lithium be provided on the negative electrode active material or on the negative electrode current collector that is in a negative electrode region that does not oppose the positive electrode active material of the positive electrode across a separator.

It is preferable that in the manufacturing method of the present invention, the negative electrode be an electrode in which the metallic lithium is affixed onto the negative electrode active material or onto the negative electrode current collector in advance. As described above, the region in which the metallic lithium is affixed is preferably a region that does not oppose the positive electrode active material of the positive electrode across the separator. When affixing the metallic lithium to the negative electrode active material, the negative electrode active material near the portion in which the metallic lithium is affixed will be pre-doped with a large amount of lithium. Therefore, by arranging the region pre-doped with a large amount of lithium in the region that does not oppose the positive electrode, a capacity reduction caused by the pre-doping with lithium can be lessened.

The metallic lithium that is enclosed in the battery case for the pre-doping disappears as the negative electrode active material is pre-doped with lithium. It is preferable to use the metallic lithium in such an amount that it can completely disappear.

When the negative electrode and the positive electrode are accommodated in the battery case in such a manner that they are layered and coiled around with a separator interposed therebetween, metallic lithium is affixed in the innermost portion and the outermost portion of the negative electrode in the coiled condition. Since the lithium intercalation from the metallic lithium to the negative electrode active material is a local battery reaction, it takes time for the entire negative electrode that is coiled to occlude lithium. Affixing the metallic lithium onto the innermost portion and the outermost portion of the negative electrode separately can shorten the time it takes for the entire negative electrode to occlude lithium. Moreover, when the metallic lithium is affixed to a further larger number of locations, the required time can be shortened further.

When the negative electrode and the positive electrode are accommodated in the battery case in a coiled condition as described above, inserting metallic lithium between the negative electrode and the separator results in a complicated process. In that case, the step of affixing the metallic lithium can be made simple by attaching a metal foil such as a copper foil onto a peripheral surface of the negative electrode and affixing metallic lithium onto the metal foil. Examples of the method for affixing the metallic lithium onto the metal foil may include pressing the metallic lithium against the metal foil.

In the present invention, the amount of metallic lithium used for the pre-doping may be found from area S (cm²) in which the negative electrode active material is formed and capacity C (mAh/cm²) corresponding to the amount of lithium to be pre-doped per unit area, using the following equation.
Amount of metallic lithium M (g)=(C×3.6/96500)×6.94×S

In the equation, 3.6 is a value for converting capacity (mAh) into quantity of electricity (C: coulomb), 96500 is the Faraday constant, and 6.94 is the atomic weight of lithium. It should be noted that 1 mAh represents the quantity of electricity when current is passed through at 1.0×10⁻³ A for 1 hour, and 1 C (coulomb) is the quantity of electricity when current is passed through at 1 A for 1 second. Accordingly, 1 mAh=3.6 C (coulomb).

Examples of the method for affixing metallic lithium onto the negative electrode active material or onto the negative electrode current collector may include pressing the metallic lithium against the negative electrode active material layer or the negative electrode current collector to affix the metallic lithium thereon.

In the present invention, it is preferable that the current collector surface be provided with irregularities as described above. For this reason, it is preferable that the current collector surface be roughened. The arithmetical mean roughness Ra of the current collector surface is preferably 0.1 μm or greater, and more preferably from 0.1 μm to 1 μm. Arithmetical mean roughness Ra is defined in Japanese Industrial Standard (JIS B 0601-1994). The arithmetical mean roughness Ra can be measured by, for example, a surface roughness meter.

Examples of a method for roughening the surface of the current collector include plating, vapor deposition, etching, and polishing. Plating and the vapor deposition are techniques for roughening the current collector surface by forming, on a current collector made of a metal foil, a thin film layer that has irregularities in its surface. Examples of the plating include electroplating and electroless plating. Examples of the vapor deposition include sputtering, CVD, and evaporation. Examples of the etching include techniques by physical etching and chemical etching. Examples of the polishing include polishing using sandpaper and polishing by blasting.

In the present invention, it is preferable that the current collector be formed of a conductive metal foil. Illustrative examples of the conductive metal foil include those made of a metal such as copper, nickel, iron, titanium, and cobalt, or of an alloy made of combinations thereof. Those containing a metal element that easily diffuses into the materials for the active material are especially preferable. Examples of such a foil include a metal foil containing copper, especially a copper foil or a copper alloy foil. It is preferable that a heat-resistant copper alloy foil be used as the copper alloy foil. The heat-resistant copper alloy refers to a copper alloy that has a tensile strength of 300 MPa or greater after annealing at 200° C. for 1 hour. Usable examples of the heat-resistant copper alloy include the alloys listed in Table 1 below. A preferable example is a current collector in which a copper layer or a copper alloy layer is provided on a heat-resistant copper alloy foil by an electrolytic process in order to increase the arithmetical mean roughness Ra.

TABLE 1
(Percentage: wt. %)

| Alloy | Composition |
|---|---|
| tin-containing copper | 0.05-0.2% of tin and 0.04% or less of |
| | phosphorus are added to copper |
| silver-containing copper | 0.08-0.25% silver is added to copper |
| zirconium copper | 0.02-0.2% zirconium is added to |
| (Used for Examples) | copper |
| chromium copper | 0.4-1.2% chromium is added to copper |
| titanium copper | 1.0-4.0% titanium is added to copper |
| beryllium copper | 0.4-2.2% beryllium and trace amounts |
| | of cobalt, nickel and iron are added |
| | to copper |
| iron-containing copper | 0.1-2.6% iron and 0.01-0.3% |
| | phosphorus are added to copper |
| high strength brass | 2.0% or less aluminum, 3.0% or less |
| | manganese, and 1.5% or less iron are |
| | added to brass containing 55.0-60.5% |
| | copper |
| tin-containing brass | 80.0-95.0% copper, 1.5-3.5% tin and |
| | the rest being zinc |
| phosphor bronze | Copper being the main component, |
| | containing 3.5-9.0% tin and 0.03-0.35% |
| | phosphorus |
| aluminum bronze | 77.0-92.5% copper, 6.0-12.0% |
| | aluminum, 1.5-6.0% iron, 7.0% or less |
| | nickel and 2.0% or less manganese |
| cupro-nickel | Copper being the main component, |
| | containing 9.0-33.0% nickel, 0.40-2.3% |
| | iron, 0.20-2.5% manganese and |
| | 1.0% or less zinc |
| Corson alloy | Copper containing 3% nickel, 0.65% |
| | silicon and 0.15% magnesium |
| Cr—Zr copper alloy | Copper containing 0.2% chromium, 0.1% |
| | zirconium and 0.2% zinc |

Examples of the solute of the non-aqueous electrolyte in the present invention include, but are not limited to, LiPF₆, LiBF₄, LiCF₃SO₃, LiN(CF₃SO₂)₂, LiN(C₂F₅SO₂)₂, LiN(CF₃SO₂) (C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, and mixtures thereof.

The solvent for the non-aqueous electrolyte used in the lithium secondary battery of the present invention is not particularly limited, and any solvent may be used as long as it can be used as the solvent for a lithium secondary battery. Preferable examples of the solvent include cyclic carbonates and chain carbonates. Examples of the cyclic carbonate include ethylene carbonate, propylene carbonate, butylene carbonate, and vinylene carbonate. Among them, ethylene carbonate is especially preferable. Examples of the chain carbonate include dimethyl carbonate, methyl ethyl carbonate, and diethyl carbonate. Moreover, a mixed solvent in which two or more solvents are mixed is preferable as the solvent. In particular, it is preferable that the mixed solvent contain a cyclic carbonate and a chain carbonate. In addition, the solvent may further contain vinylene carbonate. The amount of vinylene carbonate dissolved is preferably 20 weight % or less. Dissolving vinylene carbonate can further improve cycle performance.

In addition, a mixed solvent of one of the above-mentioned cyclic carbonates and an ether-based solvent such as 1,2-dimethoxyethane or 1,2-diethoxyethane is also preferable.

In the present invention, the electrolyte may be a gelled polymer electrolyte in which an electrolyte solution is impregnated in a polymer electrolyte such as polyethylene oxide or polyacrylonitrile, or may be an inorganic solid electrolyte such as LiI and Li₃N.

In addition, in the present invention, carbon dioxide may be dissolved in the non-aqueous electrolyte. Dissolving carbon dioxide in the non-aqueous electrolyte can prevent the negative electrode active material from becoming porous due to repeated charge-discharge cycling, making it possible to further improve cycle performance. The amount of carbon dioxide dissolved is preferably 0.01 weight % or greater, and more preferably 0.1 weight % or greater.

Examples of the positive electrode active material in the present invention include lithium-containing transition metal oxides, such as LiCoO₂, LiNiO₂, LiMn₂O₄, LiMnO₂, LiCo_{0.5}Ni_{0.5}O₂, and LiNi_{0.7}Co_{0.2}Mn_{0.1}O₂, and metal oxides that do not contain lithium, such as MnO₂. In addition, various substances may be used without limitation as long as such substances are capable of electrochemically intercalating and deintercalating lithium.

The present invention makes available a lithium secondary battery with high discharge capacity and good cycle performance.

### DESCRIPTION OF THE PREFERRED EMBODIMENTS

Hereinbelow, the present invention is described in further detail based on examples thereof. It should be construed, however, that the present invention is not limited to the following examples, and that various changes and modifications are possible without departing from the scope of the invention.

Experiment 1

Preparation of Negative Electrode

A copper alloy foil the surface of which was roughened by precipitating copper on a surface of a heat-resistant rolled copper alloy foil by an electrolytic process (arithmetical mean roughness Ra: 0.25 μm, thickness: 25 μm) was used as a current collector. On this current collector, an amorphous silicon thin film was deposited under the conditions shown in Table 2 to prepare an electrode. Although a direct current pulse was supplied as electric power for sputtering herein, the sputtering is also possible with direct current or with high frequency under the same conditions. In Table 2, the unit “sccm” denoting flow rate represents standard cubic centimeter per minute.

TABLE 2

| | | |
|---|---|---|
| DC pulse frequency | 100 | kHz |
| DC pulse width | 1856 | ns |
| DC pulse power | 2000 | W |
| Argon flow rate | 60 | sccm |
| Gas pressure | 2.0-2.5 × 10⁻¹ | Pa |
| Deposition duration | 175 | minutes |
| Film thickness | 6 | μm |

The resulting thin film was cut out together with the current collector into a 25 mm×25 mm size film, which was used as a negative electrode.

Preparation of Electrolyte Solution A

LiPF₆ was dissolved at a concentration of 1 mole/liter into a mixed solvent of propylene carbonate (PC) and diethyl carbonate (DEC) in a 9:1 volume ratio. Thus, an electrolyte solution A was prepared.

Preparation of Electrolyte Solution B

An electrolyte solution B was prepared by adding 2 parts by weight of vinylene carbonate (VC) to 100 parts by weight of the electrolyte solution A.

Measurement of Total Capacity of Negative Electrode

The total capacity of the negative electrode that does not contain lithium was measured. Specifically, a three-electrode cell was prepared using the above-described negative electrode as a working electrode and metallic lithium as its counter electrode and a reference electrode. The cell was charged to a potential of 0 V (vs. Li/Li+) to a current density of 1 mA/cm² to find the charge capacity at the first cycle, and this was employed as the total capacity of the negative electrode. Consequently, the total capacity of the negative electrode thus obtained was 5.0 mAh/cm². The result was the same in either case where the electrolyte solution A or the electrolyte solution B was used as the electrolyte solution.

Preparation of Positive Electrode

Li₂Co₃ and CoCO₃, used as starting materials, were weighed so that the atomic ratio of Li:Co became 1:1, and were mixed in a mortar. The mixture was formed by pressing it with a 17 mm diameter stamping die, and thereafter baked in air at 800° C. for 24 hours, to obtain a baked substance of LiCoO₂. The resultant substance was pulverized in a mortar into an average particle size of 20 μm.

90 parts by weight of the resultant LiCoO₂ powder and 5 parts by weight of artificial graphite powder as a conductive agent were mixed into a 5 weight % N-methylpyrrolidone solution containing 5 parts by weight of polyvinylidene fluoride as a binder, to prepare a positive electrode mixture slurry.

This positive electrode mixture slurry was applied onto an aluminum foil serving as a current collector and dried, and thereafter the current collector with the positive electrode mixture slurry was pressure-rolled. The resultant material was cut out into a size of 20 mm×20 mm. Thus, a positive electrode was prepared.

Measurement of Total Capacity of Positive Electrode

A three-electrode cell was prepared using the above-described positive electrode to obtain the total capacity of the positive electrode. Specifically, the cell was charged and discharged at a current density of 1 mA/cm² in a potential range of from 2.75 V to 4.3 V (vs. Li/Li+), to find the discharge capacity at the first cycle, and this was employed as the total capacity of the positive electrode. The total capacity of the positive electrode thus obtained was 2.6 mAh/cm². The result was the same in either case where the electrolyte solution A or the electrolyte solution B was used as the electrolyte solution.

Pre-Doping Negative Electrode

Three-electrode cells were prepared using the above-described negative electrode as the working electrodes, metallic lithium as the counter electrodes and the reference electrodes, and the electrolyte solution A. Five negative electrodes were charged so that the charge capacities were 0.88 mAh (0.14 mAh/cm²), 2.36 mAh (0.38 mAh/cm²), 3.83 mAh (0.61 mAh/cm²), 6.25 mAh (1.0 mAh/cm²), and 10.0 mAh (1.6 mAh/cm²), respectively, and the negative electrodes were pre-doped with lithium. These electrodes are referred to as Electrodes a1 to a5. Two samples of each of these pre-doped electrodes were prepared for Batteries A1 to A5 and Batteries B1 to B5.

In addition, two samples of electrodes that were not pre-doped were also prepared. The electrodes that were not pre-doped are referred to as Electrode a0.

Preparation of Batteries

### EXAMPLES 1 TO 4 AND COMPARATIVE EXAMPLES 1 AND 2

Lithium secondary batteries were fabricated using each of the foregoing electrodes a0 to a5, the foregoing positive electrode, and the electrolyte solution A. Specifically, for each battery, an electrode assembly was prepared by sandwiching a separator made of porous polyethylene between the positive electrode and the negative electrode, and the electrode assembly was inserted into a battery case made of a laminate film. Next, 500 μL of the electrolyte solution A was filled into each battery, to prepare Batteries A0 to A5. Each of the batteries had a design capacity of 10.4 mAh.

### EXAMPLES 5 TO 8 AND COMPARATIVE EXAMPLES 3 AND 4

Batteries B0 to B5 were fabricated in the same manner as above except that the electrolyte solution B was used.

Each of the batteries had a design capacity of 10.4 mAh.

Evaluation of Charge-Discharge Characteristics

The charge-discharge cycle performance of Batteries A0 to A5 and B0 to B5 were evaluated. Each of the batteries was charged at 25° C. with a current of 10.4 mA to 4.2 V and thereafter discharged with a current of 10.4 mA to 2.75 V. This process was defined as one charge-discharge cycle. The charge capacities and discharge capacities at the first cycle are shown in Table 3. The amounts of remaining lithium were calculated from the charge capacities and discharge capacities at the first cycle and the capacities obtained in the pre-doping using the three-electrode cells, which are also shown in Table 3. In addition, Li proportion was calculated from the amounts of remaining Li using the following equation. The Li proportion represents the proportion of remaining Li with respect to the total capacity of the negative electrode active material at the end-of-discharge state
Li proportion (%)=(Amount of remaining Li after the initial charge-discharge process)/(Total capacity of the negative electrode)×100

In addition, charging and discharging were repeated 50 times under the conditions of the foregoing charge-discharge cycle to find the discharge capacity and capacity retention ratio at the 50^{th} cycle. The results are shown in Table 3. The capacity retention ratio was calculated according to the following equation.
Capacity retention ratio (%)=(Discharge capacity at the 50^{th} cycle)/(Discharge capacity at the first cycle)×100

TABLE 3

| | | | 1^{st} Cycle | | | | 50^{th} Cycle | |
|---|---|---|---|---|---|---|---|---|
| | | | Charge | Discharge | Amount of | Li | Discharge | Capacity |
| | | | capacity | capacity | remaining Li | proportion | capacity | retention |
| | Electrode | Battery | (mAh) | (mAh) | (mAh/cm²) | (%) | (mAh) | ratio (%) |
| Comp. | a0 | A0 | 10.8 | 9.8 | 0.25 | 5.0 | 5.5 | 56.7 |
| Ex. 1 | | | | | | | | |
| Comp. | a1 | A1 | 11.1 | 10.4 | 0.33 | 6.5 | 5.6 | 53 |
| Ex. 2 | | | | | | | | |
| Ex. 1 | a2 | A2 | 11.1 | 10.4 | 0.55 | 11.1 | 6.4 | 61.5 |
| Ex. 2 | a3 | A3 | 10.7 | 10.1 | 0.75 | 15 | 7.1 | 70.0 |
| Ex. 3 | a4 | A4 | 10.9 | 9.7 | 1.30 | 26 | 9.2 | 94.8 |
| Ex. 4 | a5 | A5 | 10.7 | 10.1 | 1.75 | 35 | 9.9 | 98.0 |

Batteries B0 to B5 were also evaluated in the same manner as described above. The results of the evaluation are shown in Table 4.

TABLE 4

| | | | 1^{st} Cycle | | | | 50^{th} Cycle | |
|---|---|---|---|---|---|---|---|---|
| | | | Charge | Discharge | Amount of | Li | Discharge | Capacity |
| | | | capacity | capacity | remaining Li | proportion | capacity | retention |
| | Electrode | Battery | (mAh) | (mAh) | (mAh/cm²) | (%) | (mAh) | ratio (%) |
| Comp. | a0 | B0 | 10.9 | 9.6 | 0.33 | 6.5 | 8.6 | 89.5 |
| Ex. 3 | | | | | | | | |
| Comp. | a1 | B1 | 11.1 | 10.4 | 0.33 | 6.5 | 9.2 | 88.4 |
| Ex. 4 | | | | | | | | |
| Ex. 5 | a2 | B2 | 10.8 | 10.2 | 0.53 | 10.6 | 9.8 | 96.0 |
| Ex. 6 | a3 | B3 | 10.7 | 10.1 | 0.75 | 15 | 10.1 | 100 |
| Ex. 7 | a4 | B4 | 10.5 | 9.9 | 1.30 | 26 | 9.9 | 100 |
| Ex. 8 | a5 | B5 | 10.7 | 10.1 | 1.75 | 35 | 10.1 | 100 |

Tables 3 and 4 clearly demonstrate that when the Li proportion is 8% or greater, the discharge capacities and capacity retention ratios at the 50th cycle are high, which means that the discharge capacity and cycle performance improve. It will also be appreciated that when the Li proportion is 20% or greater, the discharge capacity and cycle performance further improve.

From the comparison between Tables 3 and 4, it will also be appreciated that the discharge capacity and cycle performance of the batteries further improve when the non-aqueous electrolyte contains vinylene carbonate.

Experiment 2

Preparation of Negative Electrode

A negative electrode was prepared in the same manner as in Experiment 1 above except that the electrode was prepared by depositing an amorphous silicon thin film on the current collector under the conditions set forth in Table 5.

TABLE 5

| | | |
|---|---|---|
| DC pulse frequency | 100 | kHz |
| DC pulse width | 1856 | ns |
| DC pulse power | 2000 | W |
| Argon flow rate | 60 | sccm |
| Gas pressure | 2.0-2.5 × 10⁻¹ | Pa |
| Deposition duration | 146 | minutes |
| Film thickness | 5 | μm |

The total capacity of the resultant negative electrode was obtained using a three-electrode cell employing metallic lithium for the counter electrode and the reference electrode, and was found to be 3.8 mAh/cm².

The resultant negative electrode was cut out together with the current collector into a size of 33.5 mm×240 mm, and a negative electrode current collector tab was attached thereto for use as a negative electrode.

Preparation of Positive Electrode

A positive electrode was prepared in the same manner as in Experiment 1 above.

The total capacity of the resultant positive electrode was obtained using a three-electrode cell and was found to be 2.6 mAh/cm².

The resultant positive electrode was cut out into a size of 31.5 mm×262 mm, and a positive electrode current collector tab was attached thereto, for use as a positive electrode. The total area of both sides of the positive electrode was 165 cm², but the area on which the active material was applied on both sides of the current collector was 105 cm².

Preparation of Batteries

### EXAMPLE 9

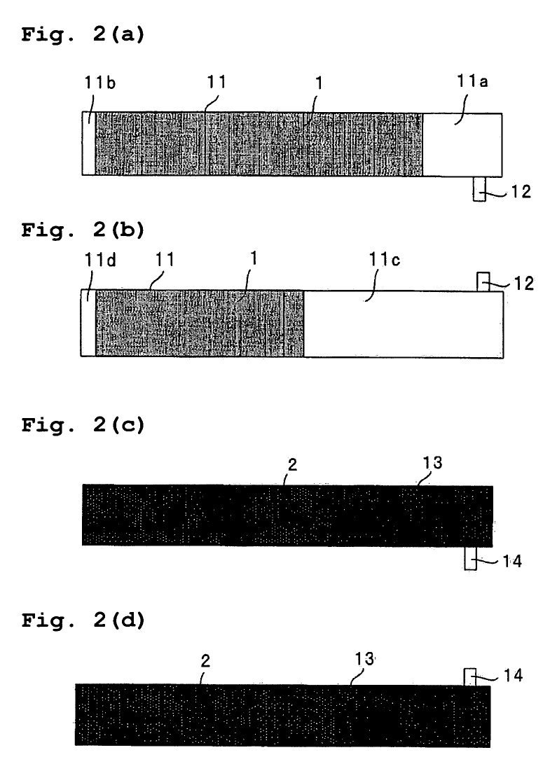

FIG. 2 show plan views illustrating the positive electrode and the negative electrode. FIG. 2(a) shows the obverse side of the positive electrode, FIG. 2(b) shows the reverse side of the positive electrode, FIG. 2(c) shows the obverse side of the negative electrode, and FIG. 2(d) shows the reverse side of the negative electrode, respectively.

As illustrated in FIG. 2(a), the positive electrode is formed by applying a positive electrode active material 1 on a positive electrode current collector 11. As shown in FIG. 2(a), a region 11b in which the positive electrode active material 1 is not provided is formed in an edge portion that is located near the center when the positive electrode is coiled around. In addition, a region 11a in which the positive electrode active material 1 is not provided is formed in a wider area than the region 11b in an edge portion that is located near the outside when the electrode is coiled around. Likewise, on the reverse side as well, a region 11d in which the positive electrode active material 1 is not provided is formed in an edge portion that is located near the center when the electrode is coiled around as illustrated in FIG. 2(b), and a region 11c in which the positive electrode active material 1 is not provided is formed in a wider area than the region 11d in the an edge portion that is located near the outside when the electrode is coiled around. A positive electrode tab 12 is attached outwardly to the positive electrode. The positive electrode is coiled around so that the reverse side shown in FIG. 2(b) faces outward.

As illustrated in FIGS. 2(c) and 2(d), in the negative electrode the negative electrode active material 2 is formed on the entire surfaces of the obverse side and the reverse side of the negative electrode current collector 13. A negative electrode tab 14 is attached outwardly to the negative electrode.

A lithium secondary battery was fabricated using the positive electrode and the negative electrode. A separator made of porous polyethylene was interposed between the positive electrode and the negative electrode to form an electrode assembly, and the electrode assembly was coiled around using a 18-mm diameter core and thereafter pressed.

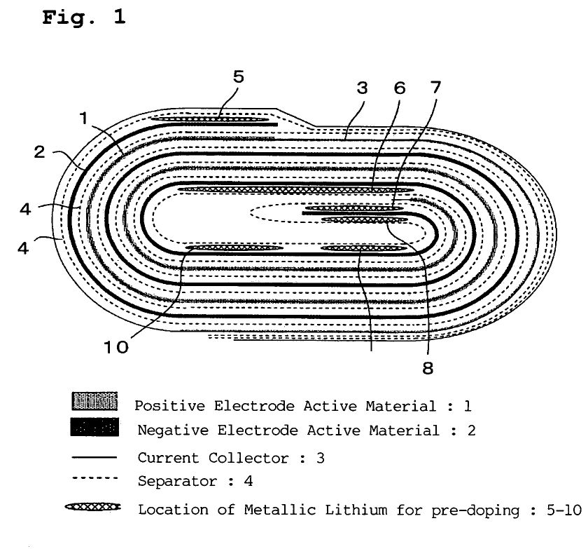

FIG. 1 is a cross-sectional view showing the electrode assembly thus coiled around. As illustrated in FIG. 1, there are regions in which the positive electrode active material 1 and the negative electrode active material 2 do not oppose each other across the separator 4 interposed therebetween. Metallic lithium can be inserted into these regions 5 to 10. In the present example, metallic lithium was inserted in the location designated by reference numeral 8. The metallic lithium was inserted under an argon atmosphere. The amount of the metallic lithium was 30 mg.

The wound assembly thus prepared was inserted into a battery case made of a laminate film, and 1 g of the electrolyte solution B, which was the same as used in Experiment 1, was filled therein. Thus, a battery C1 was fabricated. The design capacity of the battery thus fabricated was 274 mAh. It should be noted that after the electrolyte solution was filled, the metallic lithium was pre-doped into the negative electrode active material of the negative electrode by an electrochemical reaction, and thus the metallic lithium disappeared.

### COMPARATIVE EXAMPLE 5

Battery C2 was fabricated in the same manner as in the foregoing except that metallic lithium was not inserted in the wound assembly.

Evaluation of Charge-Discharge Characteristics

The foregoing Batteries C1 and C2 were evaluated in terms of charge-discharge cycle performance. Each of the batteries were charged at 25° C. with a current of 274 mA to 4.2 V, and thereafter charged at a constant voltage of 4.2 V until the current reaches 13.7 mA. Thereafter, each battery was discharged with a current of 274 mA to a battery voltage of 2.75 V. This process was defined as one charge-discharge cycle. Charging and discharging were repeated under these conditions up to 40 cycles, and the capacity retention ratio defined by the following equation was calculated for each of the batteries.
Capacity retention ratio (%)=(Discharge capacity at the 40th cycle)/(Discharge capacity at the first cycle)×100

It should be noted that the charge capacities, the discharge capacities, the amounts of remaining Li, and the Li proportions at the first cycle were calculated in the same manner as in Experiment 1. The results are shown in Table 6.

TABLE 6

| | | 1^{st} Cycle | | | | 40^{th} Cycle | |
|---|---|---|---|---|---|---|---|
| | | Charge | Discharge | Amount of | Li | Discharge | Capacity |
| | | capacity | capacity | remaining Li | proportion | capacity | retention |
| | Battery | (mAh) | (mAh) | (mAh/cm²) | (%) | (mAh) | ratio (%) |
| Ex. 9 | C1 | 292 | 271 | 0.9 | 17.5 | 271 | 100 |
| Comp. Ex. 5 | C2 | 290 | 260 | 0.3 | 7 | 200 | 77 |

The results shown in Table 6 clearly demonstrate that Battery C1 of Example 9, in which metallic lithium was brought into contact with the negative electrode to pre-dope lithium into the negative electrode active material of the negative electrode, showed a higher discharge capacity and moreover a higher capacity retention ratio. Thus, it is understood that the discharge capacity and the cycle performance improved.

As described above, according to the present invention, it is possible to prevent the negative electrode active material from deteriorating because of repeated charge-discharge cycling by pre-doping the negative electrode active material with lithium so that 8% or more of lithium is contained in the negative electrode active material in the end-of-discharge condition with respect to the total capacity of the negative electrode active material, and thus, it becomes possible to attain high discharge capacity and good cycle performance.

Experiment 3

### EXAMPLE 10

A wound electrode as shown in FIG. 1 was prepared in the same manner as in Experiment 2. Then, a battery was fabricated in the same manner as in Example 9 except that 42 mg of metallic lithium was affixed at a location designated by reference numeral 6 in FIG. 1.

### EXAMPLE 11

A battery was fabricated in the same manner as in Example 10 except that 30 mg of metallic lithium was affixed at a location designated by reference numeral 5 in FIG. 1 and 12 mg of metallic lithium was affixed at a location designated by reference numeral 6.

### EXAMPLE 12

A battery was fabricated in the same manner as in Example 10 except that 20 mg of metallic lithium was affixed at a location designated by reference numeral 5 in FIG. 1, that 12 mg of metallic lithium was affixed at a location designated by reference numeral 6, and that 10 mg of metallic lithium was affixed at a location designated by reference numeral 9.

These batteries underwent aging for 3 days at 60° C., and thereafter the weight of metallic lithium was weighed. The results are as follows.

Example 10: 15 mg

Example 11: 9.5 mg

Example 12: 7 mg

These results indicate that the rate of dissolving metallic lithium is faster when affixing metallic lithium at a plurality of locations than when affixing metallic lithium at a single location, allowing lithium to be absorbed in the negative electrode active material more quickly. Thus, by affixing metallic lithium at a plurality of separate locations, the duration of aging process can be shortened.

Experiment 4

Batteries were fabricated in the same manner as in Example 9 using positive electrodes having a discharge capacity of 2.6 mAh/cm² and negative electrodes having a discharge capacity of 3.0 mAh/cm², and affixing 20 mg of metallic lithium thereto in the following manner.

### EXAMPLE 13

In the present example, 20 mg of metallic lithium was affixed at only the location designated by reference numeral 6 in FIG. 1.

### EXAMPLE 14

In the present example, 10 mg of metallic lithium was affixed at the location designated by reference numeral 5 in FIG. 1, and 10 mg of metallic lithium at the location designated by reference numeral 6.

The batteries using the negative electrodes of Examples 13 and 14 were subjected to an aging process. Then the batteries were charged at a constant current of 273 mA to 4.35 V, and thereafter charged at a constant voltage until the current reached 14 mA.

The batteries in a charged state were disassembled to observe the conditions of the negative electrodes.

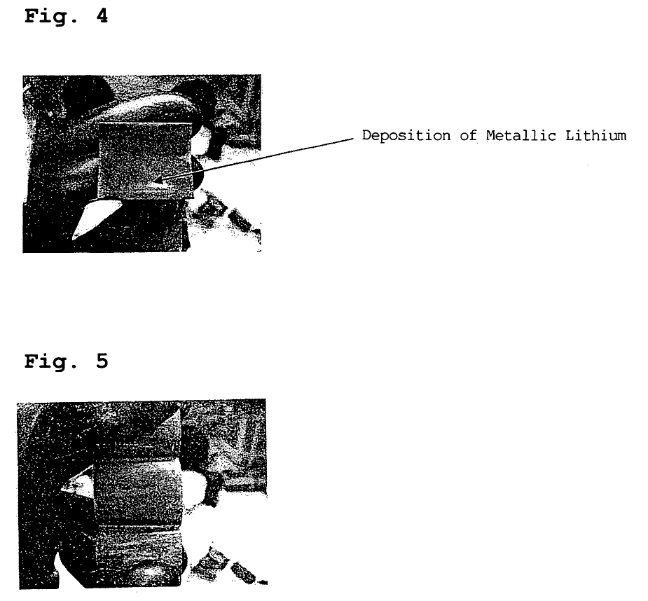

FIG. 4 is a view showing the condition of the negative electrode of Example 13, and FIG. 5 is a view showing the condition of the negative electrode of Example 14.

FIG. 4 clearly shows that, in the negative electrode of Example 13, in which metallic lithium was provided on one location, metallic lithium deposited on the region of the negative electrode that opposes the positive electrode. On the contrary, in Example 14, in which metallic lithium was provided at a plurality of separate locations, metallic lithium did not deposit, as shown in FIG. 5.

Experiment 5

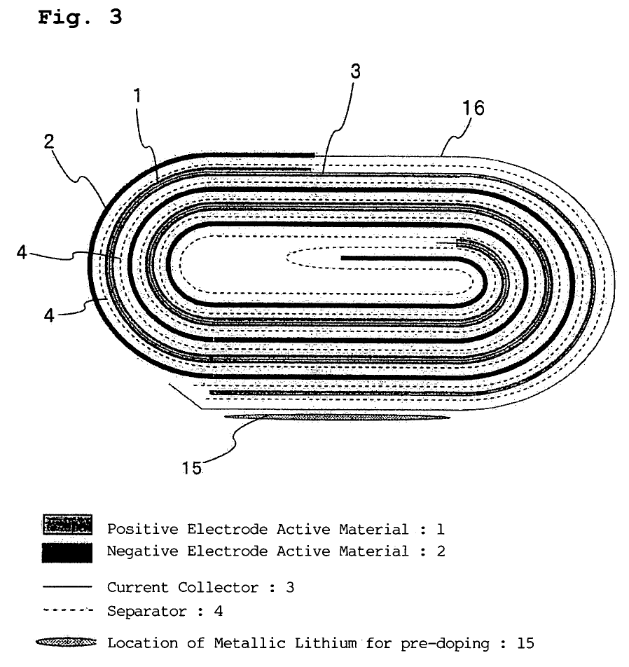

FIG. 3 illustrates an electrode assembly in which the negative electrode and the positive electrode are coiled around with a separator interposed therebetween, as in Experiment 2. In the example shown in FIG. 3, a copper foil 16 is attached and electrically connected to an outer peripheral edge portion of the negative electrode 2. By providing metallic lithium 15 onto the copper foil 16 thus attached, the step of affixing the metallic lithium is made simple. Consequently, the yield rate in battery fabrication can be also improved.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for the purpose of limiting the invention as defined by the appended claims and their equivalents.

This application claims priority of Japanese patent application Nos. 2004-318732 filed Nov. 2, 2005, and 2005-099037 filed Mar. 30, 2005, which are incorporated herein by reference.

What is claimed is:

1. A lithium secondary battery comprising:
a negative electrode having a negative electrode active material and a negative electrode current collector;
a positive electrode; and
a non-aqueous electrolyte, wherein
the negative electrode active material is composed of a material that increases in volume by alloying with lithium during charge, and the negative electrode active material is directly in contact with the negative electrode current collector; and
the negative electrode active material contains, when in an end-of-discharge condition, 8% or more of lithium with respect to a total capacity of the negative electrode active material as measured when the negative electrode active material does not contain lithium.

2. The lithium secondary battery according to claim 1, wherein the negative electrode is formed by depositing a thin film of the negative electrode active material on the negative electrode current collector from a vapor phase or a liquid phase, the thin film is divided by gaps that form along its thickness to form columnar structures, and bottom portions of the columnar structures are in close contact with the negative electrode current collector.

3. The lithium secondary battery according to claim 1, wherein the negative electrode active material is an amorphous thin film or a microcrystalline thin film.

4. The lithium secondary battery according to claim 3, wherein the thin film is a silicon thin film or a silicon alloy thin film.

5. The lithium secondary battery according to claim 1, wherein the negative electrode active material is silicon alloy.

6. The lithium secondary battery according to claim 1, wherein the negative electrode active material is pre-doped with lithium prior to charge and discharge.

7. A method of manufacturing a lithium secondary battery according to claim 1, comprising the steps of:
prior to assembling the battery, preparing the negative electrode, the positive electrode, the non-aqueous electrolyte, and a battery case for accommodating the electrodes and the electrolyte;
pre-doping the negative electrode active material with lithium prior to charge and discharge so that 8% or more of lithium will be contained in the negative electrode active material in the end-of-discharge condition; and
completing the lithium secondary battery with the negative electrode pre-doped with lithium, the positive electrode, the non-aqueous electrolyte, and the battery case.

8. The method according to claim 7, wherein the step of pre-doping comprises electrochemically pre-doping the negative electrode active material with lithium.

9. The method according to claim 8, wherein the step of pre-doping comprises disposing the negative electrode and the positive electrode in the battery case, and introducing the non-aqueous electrolyte in the battery case while a partial region of the negative electrode is in contact with metallic lithium to pre-dope the negative electrode active material with lithium from the metallic lithium.

10. The method according to claim 9, wherein the region of the negative electrode that is in contact with the metallic lithium is a region of the negative electrode active material or a region of the negative electrode current collector that does not oppose a positive electrode active material of the positive electrode.

11. The method according to claim 9, wherein the negative electrode and the positive electrode are accommodated in the battery case in a coiled condition with a separator interposed therebetween, and the metallic lithium is affixed to an innermost portion and an outermost portion of the negative electrode in the coiled condition.

12. The method according to claim 11, wherein the metallic lithium is affixed at a plurality of separate locations.

13. The method according to claim 11, wherein a metal foil is attached to an outer peripheral edge portion of the negative electrode, and the metallic lithium is affixed onto the metal foil.

14. The method according to claim 9, wherein the negative electrode is an electrode in which the metallic lithium is affixed onto the negative electrode active material or onto the negative electrode current collector in advance.
